(19) United States
(12) Patent Application Publication
(10) Pub. No.: US 2010/0223027 A1
(43) Pub. Date: Sep. 2, 2010

(54) MONITORING METHOD FOR MULTI TOOLS

(75) Inventors: YIJ CHIEH CHU, TAIPEI COUNTY (TW); CHUN CHI CHEN, TAIPEI CITY (TW); YUN-ZONG TIAN, TAICHUNG COUNTY (TW); SHIH CHANG KAO, KAOHSIUNG CITY (TW); CHENG-HAO CHEN, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., TAOYUAN COUNTY 333 (TW)

(21) Appl. No.: 12/471,722

(22) Filed: May 26, 2009

(30) Foreign Application Priority Data
Mar. 2, 2009 (TW) 98106632

(51) Int. Cl. G21C 17/00

(52) U.S. Cl. 702/182

(57) ABSTRACT

A monitoring method for multi tools is disclosed. The method includes the steps of providing a plurality of measurement tools for measuring the testing points of standard wafers, calculating a vector for representing a measurement tool, calculating the angle between every two of the vectors and determining the measurement tools having the same performance or not. Thereby, the measurement tools can be efficiently grouped and the measuring stability of the measurement tool is analyzed.

### BACKGROUND OF THE INVENTION

1. Field of the Invention

The present invention relates to a monitoring method for multi tools, in particular to a monitoring method for grouping the measurement tools and analyzing the stability of the measurement tools.

2. Description of Related Art

With the high performance of the electronic products, it is necessary for developing the manufacturing technology of semiconductors. The quality control is a method to determine whether the processes are stable by analyzing the data measured by measurement tools. Because most data is obtained by the measurement tools, the errors of the measurement tools, operators, or inspection methods will take much influences on the precision of the analyzed result. It is difficult for solving the causes of the processes depending on the wrong analysis. Therefore, GR&R (Gauge R&R) is used to analyze the measurement tools in the quality control system.

GR&R can be used for indicating the repeatability and the reproducibility of the measurement system. The measurement system includes the equipment used in the factory. GR&R is a method of regular analysis of variance (ANOVA) and it is used for analyzing and evaluating the measurement system by average and long-term concept.

Please refer to FIG. 1; the usage of GR&R is shown. However, GR&R has the following advantages. GR&R is not sensitive to the sudden error on the data of long time. On the other hand, GR&R is based on the average performance of each tools and the systemic difference between these tools can not be indicated by GR&R method. Furthermore, the measurement ability of the tool is changing in time sequence. Thus, it is difficult to distinguish the tools using the method of GR&R.

Therefore, in view of this, the inventor proposes the present invention to overcome the above problems based on his expert experience and deliberate research.

### SUMMARY OF THE INVENTION

The primary object of the present invention is to provide a monitoring method for multi tools. The eigenvectors and eigenvalues are used for analyzing the stability of each measurement and determining the difference between one measurement tool and another in the present method. Therefore, the measurement data can be efficiently analyzed for engineers.

To achieve the above-mentioned objective, the present invention provides a method for monitoring multi tools. The method includes the following steps. Step 1 is providing a plurality of measurement tools for measuring a plurality of testing points on at least one standard wafer in a predetermined time period. Step 2 is calculating a vector for representing each measurement tool. Step 3 is calculating an angle difference between one vector and another vector. The last step is determining whether the measurement tools having the same measuring performance via the angle differences.

The method is provided for representing one measurement tool as one vector which is calculated via a matrix of variance. Therefore, the difference between one measurement tool and another measurement tool can be efficiently analyzed so as to group and classify the measurement tools. Moreover, the method of present invention can be used for determining the stability of the measurement tools.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 shows the traditional method of GR&R.

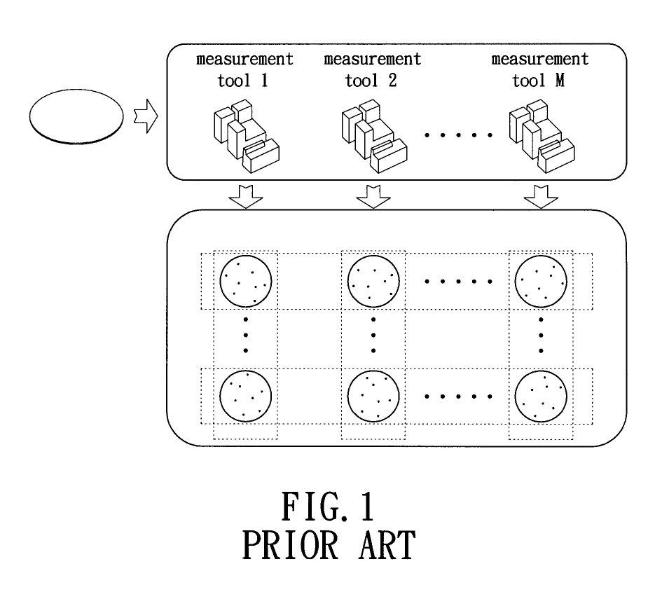

FIG. 2 shows the steps of the monitoring method for multi tools according to the present invention.

FIG. 3 shows two eigenvectors re presenting two measurement tools and shows calculating the angle difference between the two eigenvectors according to the present invention.

FIG. 4 shows the relation between the stability of tools and the measurement time period according to the present invention.

### DETAILED DESCRIPTION OF THE PREFERRED EMBODIMENTS

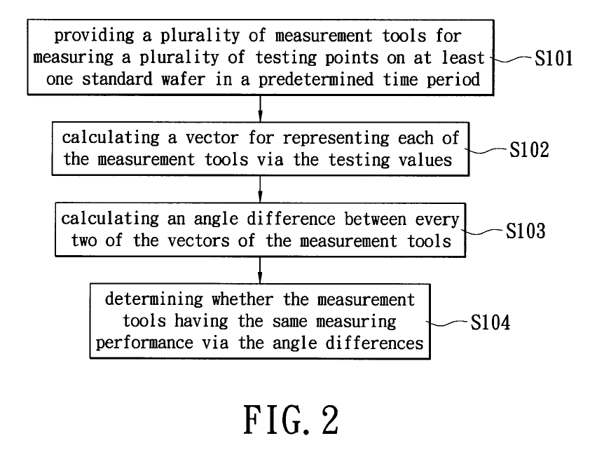

Please refer to FIG. 2; the present invention provides a monitoring method for multi tools. The monitoring method can be provided for analyzing the stability of measurement tool and for comparing the measurement tools with the measuring performance of the measurement tools so as to differ the measurement tools. The monitoring method includes the following step.

Step S101 is provided for measuring the testing values of the testing points on a standard wafer. In this step, a plurality of measurement tools are provided for measuring the testing values of the testing points on the standard wafer in a predetermined time period. Regarding with the standard wafer, the testing values of the testing points on the standard wafer by a measurement tool is much similar (or the same) in the different measuring time, in case of the measurement tool with high stability. Therefore, the standard wafer is used for determining the stability of the measurement tool. The predetermined time period is a selected time period and it means ten days in the embodiment. Thus, the testing data has testing values collected from ten days ago to today and the testing data is analyzed.

After collecting data, a step for removing the unreasonable data so as to improve the precision of the analysis.

Step S102 is provided for calculating the testing values measured by a measurement tool so as to representing the measurement tool by a vector. In the step, the testing values measured by a measurement tool are put in a data matrix, for example, a matrix of variance to calculate the vectors representing each measurement tools respectively. Please refer to the matrix as following:

$$X = [ \begin{matrix}{y}_{1 , 1} & … & {y}_{1 , p} \\ ⋮ & ⋱ & ⋮ \\ {y}_{n , 1} & … & {y}_{n , p}\end{matrix} ]$$

Wherein n is the amount of the standard wafers and p represents the testing points. Y represents the testing values measured by the measurement tools, such as thickness.

On the other hand, a step of calculating an eigenvalue via the vector representing each of the measurement tools and determining a stability of each of the measurement tools is provided after the step of the calculating a vector for representing each of the measurement tools. The eigenvalue can be calculated by the matrix of variance. In other words, the diagonal matrix of the eigenvalue can be shown as following by analyzing the matrix of variance.

Λ=└λ₁, λ₂, . . . , λₚ┘

Λ is the diagonal matrix of the eigenvalue and λ represents the eigenvalues of a measurement tool. Furthermore, the stability of a measurement tool can be determined via the eigenvalues of a measurement tool, shown as following:

$$L = \frac{Max ( {λ}_{i} )}{{\sum }_{i = 1}^{p} {λ}_{i}}$$

L represents the stability of each the measurement tool the value of L can be used to determine whether the measurement tool is in stable state. It means that user can know the testing values measured by a measurement tool are stable, similar or ratio-related. The stability of each the measurement tool is determined by the space distance. In the present embodiment, when the value of L is larger than 0.9, the measurement tool is in stable state.

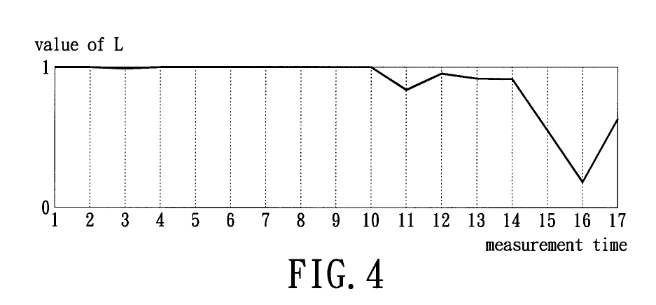

Please refer to Table. 1 and FIG. 4; Table. 1 is the stability table which shows measurement tool A to E in the 17 times of measurements.

TABLE 1

| | M1 | M2 | M3 | M4 | M5 | M6 | M7 | M8 | M9 |
|---|---|---|---|---|---|---|---|---|---|
| tool A | 0.9964 | 0.9196 | 0.9251 | 0.9570 | 0.9811 | 0.9988 | 0.9998 | 0.9969 | 0.9988 |
| tool B | 0.9984 | 0.9991 | 0.9996 | 0.9999 | 1.0000 | 1.0000 | 0.9999 | 0.9999 | 0.9997 |
| tool C | 0.9968 | 0.9928 | 0.9038 | 0.9987 | 0.9985 | 0.9987 | 0.9993 | 0.9985 | 1.0000 |
| tool D | 0.9974 | 0.9972 | 0.9971 | 0.9951 | 0.9957 | 0.9978 | 0.9979 | 0.9975 | 0.9941 |
| tool E | 0.9828 | 0.9866 | 0.9852 | 0.9816 | 0.9882 | 0.9919 | 0.9746 | 0.9674 | 0.8518 |

| | M10 | M11 | M12 | M13 | M14 | M15 | M16 | M17 |
|---|---|---|---|---|---|---|---|---|
| tool A | 0.9994 | 0.9977 | 0.9962 | 0.9945 | 0.9961 | 0.9974 | 0.9972 | 0.9965 |
| tool B | 0.9973 | 0.9989 | 0.9979 | 0.9973 | 0.9941 | 0.9933 | 0.9947 | 0.9984 |
| tool C | 1.0000 | 0.8391 | 0.9551 | 0.9188 | 0.9152 | 0.5510 | 0.1833 | 0.6337 |
| tool D | 0.9977 | 0.9973 | 0.9972 | 0.9965 | 0.9957 | 0.9957 | 0.9992 | 0.9999 |
| tool E | 0.9633 | 0.9908 | 0.9848 | 0.9796 | 0.9508 | 0.9150 | 0.9963 | 0.9648 |

Please refer to FIG. 4; X-axis shows the measurement times (1 to 17), and Y-axis show the values of L. Tool C is in a stable state in the first ten measurements (i.e., values of L are larger than 0.9), but the value of L larger than 0.9 is shown in 11^{th} measurement. In other words, tool C is not stable and it is necessary to fix tool C.

When there are k measurement tools used for the measurement, a matrix of variance.

$${X}_{k} = [ \begin{matrix}{y}_{1 , 1 , k} & … & {y}_{1 , p , k} \\ ⋮ & ⋱ & ⋮ \\ {y}_{n , 1 , k} & … & {y}_{n , p , k}\end{matrix} ]$$

A diagonal matrix of the eigenvalue can be shown as following by analyzing the matrix of variance.

Λₖ=└λ₁, λ₂, . . . λₚ┘

Furthermore, an eigenvector of the matrix is shown as following:

Pₖ=[e′_{1,k} . . . e′_{p,k}]

The eigenvector is the vector representing each measurement tool. Therefore, the angle difference of two vectors is calculated for determining how different the two measurement tools are and the difference can be used for classifying the measurement tools.

Step S103 is calculating the angle difference of two vectors. Because each measurement tool has his own vector (i.e., the eigenvector), the angle difference of two vectors is calculated by the vector basic calculation. For example,

$$cos ( {θ}_{v , w} ) = \frac{{P}_{v} {P}_{w}}{‖ {P}_{v} ‖ \cdot ‖ {P}_{w} ‖}$$

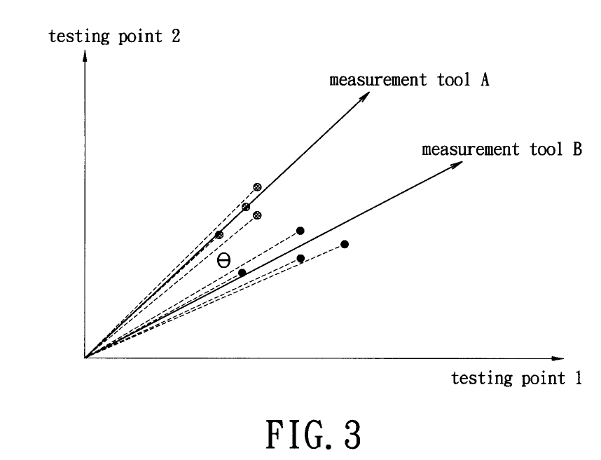

θv,w is the angle difference between measurement tool v and measurement tool w, and the Pv, Pw respectively represent the eigenvectors of measurement tool v and measurement tool w. Therefore, the measurement performances of the measurement tools are grouped by the angle difference. As clearly shown in FIG. 3, the angle difference between two vectors is used for determining the measurement tools, for example, FIG. 3 shows the difference between the tool A and tool B.

Step S104 is determining whether the measurement tools having the same measuring performance via the angle differences. In the embodiment, the angle difference between the vector of one measurement tool and the vector of another measurement tool. Table.2 shows the angle differences between two measurement tools in measurement tool A to measurement tool E. For example, the angle difference between measurement tool A and measurement tool B is 48.69 degrees and angle difference between measurement tool B and measurement tool E is 111.62 degrees. Comparing with the angle differences in Table. 2, the angle difference between measurement tool A and measurement tool B is small. The angle differences between measurement tool A and measurement tools C, D, E are larger than the angle difference between measurement tool A and measurement tool B. Similarly, depending on the angle differences between measurement tools C, D, and E, the vectors of the measurement tools C, D, and E are close to each other. In the case of the larger angle difference between two measurement tools, the two measurement tools have more different measurement performances. Thus, in the embodiment, measurement tools A and B are classified in a group and measurement tools C, D, and E are classified in another group.

TABLE 2

| | Tool A | Tool B | Tool C | Tool D |
|---|---|---|---|---|
| Tool B | 48.69 | | | |
| Tool C | 105.72 | 109.13 | | |
| Tool D | 106.05 | 122.91 | 84.71 | |
| Tool E | 104.24 | 111.62 | 59.368 | 60.44 |

Then, a step of mapping each of the measurement tools by an inserting-data method is provided after the step of determining whether the measurement tools having the same measuring performance. Because of the eigenvectors and the eigenvalues are numbers, it is not easy to organize the difference for the engineers. Therefore, the inserting-data method is used for drawing a map to show the measurement performance of each measurement tool. Thus, the maps of measurement tools A and B are similar and the maps of measurement tools C, D, and E are similar. Moreover, there are obvious difference between the map of group of measurement tools A, B and the map of group of measurement tools C, D, and E in the embodiment.

On the other hand, depending on the analysis of the eigenvectors, when the measurement tool C has unstable situation, the map of measurement tool C shows a difference between the maps of measurement tool D or E. In other words, measurement tool C is indicated as an unstable state by the map.

In summary, the present invention has the following advantages.

1. A new monitoring index is provided in the present invention. The eigenvectors calculated by the matrix of variance can be used for determining the stability of the measurement tool. Therefore, it is easy to know the state of the tools, and users can be noticed in the unstable state of a measurement tool.

2. The user can analyze the matrix of variance to obtain the eigenvector representing each measurement tool. Therefore, each measurement tool is referred to a vector and the difference between one measurement tool and another measurement tool can be efficiently determined via basic calculation of vectors. In other words, the problem of viewing the measurement tools as the same is solved.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A monitoring method for multi tools, comprising:
providing a plurality of measurement tools for measuring a plurality of testing points on at least one standard wafer in a predetermined time period and the testing values of the testing points be measured;
calculating a vector for representing each of the measurement tools via the testing values;
calculating an angle difference between two of the vectors of the measurement tools; and
determining whether the measurement tools having the same measuring performance via the angle differences.

2. The monitoring method according to claim 1, wherein the testing values measured by each of the measurement tools are calculated to provide a matrix of variance of the testing values for calculating the vector representing each of the measurement tools in the step of calculating a vector for representing each of the measurement tools.

3. The monitoring method according to claim 2, further comprising a step of calculating an eigenvalue via the vector representing each of the measurement tools and determining a stability of each of the measurement tools after the step of calculating a vector for representing each of the measurement tools.

4. The monitoring method according to claim 3, wherein a formula of
$$L = \frac{Max ( {λ}_{i} )}{{\sum }_{i = 1}^{p} {λ}_{i}}$$
being provided for determining the stability of each of the measurement tools, wherein L represents the stability of each of the measurement tools and λi is the eigenvalue of each of the measurement tools.

5. The monitoring method according to claim 4, further comprising a step of providing a table of the eigenvalues of the measurement tools in the step of calculating the eigenvalue via the vector representing each of the measurement tools.

6. The monitoring method according to claim 4, wherein the measurement tool is in the stable state when of the value of L is larger than 0.9.

7. The monitoring method according to claim 1, wherein the testing values measured by each of the measurement tools are calculated to provide a matrix of variance of the testing values, and an eigenvector of each of the measurement tools is calculated via the matrix of variance in the step of calculating a vector for representing each of the measurement tools.

8. The monitoring method according to claim 7, wherein an angle difference between two of the eigenvectors is calculated in the step of calculating the angle difference between two of the vectors.

9. The monitoring method according to claim 8, wherein a formula of
$$cos ( {θ}_{v , w} ) = \frac{{P}_{v} {P}_{w}}{‖ {P}_{v} ‖ \cdot ‖ {P}_{w} ‖}$$
is provided for calculating the angle difference between two of the eigenvectors, wherein θv,w is the angle difference between measurement tool v and measurement tool w, and the Pv, Pw respectively represent the eigenvectors of measurement tool v and measurement tool w.

10. The monitoring method according to claim 9, wherein the measurement tools are classified depending on the angle differences in the step of determining whether the measurement tools having the same measuring performance.

11. The monitoring method according to claim 10, further comprising a step of mapping each of the measurement tools by an inserting-data method after the step of determining whether the measurement tools having the same measuring performance.

12. The monitoring method according to claim 11, further comprising a step of removing unreasonable data after the step of providing the measurement tools.
